(19) United States
(12) Patent Application Publication
(10) Pub. No.: US 2017/0191303 A1
(43) Pub. Date: Jul. 6, 2017

(54) SUPPORT FRAME FOR SLIDING DOOR SYSTEMS

(71) Applicant: LINEAR BUILDING INNOVATIONS LIMITED, Houghton Regis (GB)

(72) Inventors: Hans Nicholas PURDOM, Greater London (GB); Anthony Michael HOWARD, East Sussex (GB)

(73) Assignee: LINEAR BUILDING INNOVATIONS LIMITED, Houghton Regis (GB)

(21) Appl. No.: 15/314,290

(22) PCT Filed: May 22, 2015
(86) PCT No.: PCT/GB2015/051509

§ 371 Date: Nov. 28, 2016

(30) Foreign Application Priority Data
May 28, 2014 (GB) 1409456.9

(51) Int. Cl. E06B 3/46; E06B 3/48; E05D 15/06

(52) U.S. Cl. CPC E06B 3/46; E05D 15/06; E06B 3/487; E06B 3/4636

(57) ABSTRACT

The present invention provides a frame (10) for a sliding door which sits within a pocket, wherein the frame comprises of rigid vertical posts (20), which have channels (24) which contain a beam (22) for strengthening of the posts and allowing the fastening of plasterboard or other such wall panels to the vertical posts (20).

The present invention relates to sliding door systems, and in particular a frame, or components thereof, such as the posts, stops or brackets thereof, which frame conceals or houses a door in a wall cavity when the door is in its open position. The present invention also relates to methods of assembling the frame.

Living space is an important asset and new methods for increasing the space available for use in a room are always in demand. Sliding doors, in which the door slides over an adjacent wall when open, have been utilized for many years and a variation of these is pocket doors, in which the open door is hidden in a compartment inside the adjacent wall. Such pocket doors have a very good space saving characteristic and offer a neat contemporary design by means of which there is no encroachment of the door into the room. Modern designers realise this and as a result pocket doors have made a resurgence in recent years.

In modern homes, partition walls are normally constructed from timber studwork with a plasterboard skin. This design allows a builder to leave space in the studwork not only for a doorway, but also for an internal cavity into which a sliding door may be concealed or slid. However, with the studwork removed it is necessary to provide supports onto which the outer skin of the wall, e.g. the plaster or plasterboard, can be mounted. This is in addition to providing a frame itself for the sliding door to travel within, and to be supported by, while still offering adequate wall strength.

Examples of known sliding door arrangements are provided by GB2492366, WO2011/161707, EP2299043 and EP2455573. Of most relevance to the present invention is GB2492366. It proposes a solution using an extendable support frame comprising sliding stud sections which span the space in the studwork. The stud sections include MDF inserts to allow fixing of fibreboard thereto. However, a problem with such a support frame is that when extended, the hollow studs lose rigidity and will not allow fixation of fibreboard at the extremities. An improved sliding door support frame would thus be desirable.

According to the present invention, there is provided a frame for a sliding door, the frame comprising columns formed with extruded profiles, the columns extending between upper and lower supports of the frame, the upper and lower supports being formed with extruded profiles and with multiple channels, and a rail in or along which a door can slide.

Preferably the upper and lower supports provide at least one channel for the columns to be secured within. Preferably they supply two channels, for respectively securing at least one pair of the columns.

Preferably the upper and lower supports provide at least one channel for the sliding mechanism of the door. Preferably it is a central channel.

Preferably the columns are fitted within the frame in a vertical orientation.

Preferably the profile of the column's extrusion is shaped to provide lateral rigidity.

Preferably a plurality of columns will be used. They are typically in one or more pairs.

Preferably at least a part of the frame sits within a wall cavity, e.g. in a partition wall, the cavity forming a pocket for partially containing a door within said wall cavity.

Preferably the upper and lower supports, and the columns, will be formed from metal. More preferably the metal will be a non-ferrous metal such as aluminium to allow safer grinding and cutting operations—non-ferrous metals typically have a reduced likelihood of sparking when being ground, compared to iron and steel.

Preferably the columns additionally comprise a beam bonded to, or attached to, or located within, a channel within the column. It may be formed from another material.

Preferably the beam is a solid material.

Preferably the beam is suitable for screwing or nailing into.

Preferably the beam is chosen or provided to increase the rigidity of the column.

The beam might be made of plastic, rubber, wood or a fibrous material. Most preferably the material will be wood.

Preferably the column (and when provided the beam) will be longer than required for spanning the vertical gap between the upper and lower supports. The materials selected for the columns and beams are this chosen such that they may be readily or easily cut on site to a required size or length, e.g. using tools readily carried by craftsmen usually tasked with door assembly, such as saws or grinders.

Preferably the beam is oversized in its depth dimension such that it sits proud of the profile of the column when located within the channel at least over a majority of its length. By sitting proud, it enables plasterboard to be attached to the columns for forming that part of the wall of the room, and with a reduced risk of bowing (due to the nails or screws locally pulling the plasterboard inwards of the wall).

Preferably the column has one or more groove or wedge present along its axis, for example extending along one, or more than one, side of its channel, for aligning with a corresponding one or more wedge or groove, as appropriate, in the beam, for holding the beam within the channel.

Preferably at least one of the extruded profiles has one or more groove present along its component's axis at a location where screws or nails are to be used for securing a second component in at least one of its channels. This groove may function as a guide point for the screw of nail. Furthermore such grooves can reduce incidence of slipping of the tip of fastening hardware such as the screws or nails.

Preferably there is provided within the frame at least one jamb column, formed with an extruded profile, which forms at least a part of the jamb of the frame. Preferably there is a pair of such jamb columns, one either side of the door.

Preferably the jamb column borders the wall cavity.

The jamb column's profile is preferably such that a lip extends from it to provide a surface against which a wall panel, such as plasterboard, may be seated.

Preferably the lip of the jamb column's profile extends away from the sliding door pocket to increase the rigidity of the jamb column.

Preferably the jamb column's profile is such that there is provided a groove for a sealing member to be attached thereto. The sealing member may be a brush which is arranged such that it can seal or brush against the face of the door. It may serve as a visual blockage (for concealing the cavity—which cavity may otherwise be relatively unappealing), or it may offer a draught seal, or a means for reducing door movement/door-rattle through airflow either side of the door.

Preferably the inside edge of the jamb column has a flat surface such that a visible finishing surface may be placed flush against it.

Preferably the inside edge of the jamb column has a lip for securing a post against, said post forming a further part of the jamb of the frame.

Preferably the post is formed from a solid piece of material.

Preferably the post is formed from wood.

Preferably the post has a groove in its profile for holding a seal. Preferably this seal will face a front or back surface of the door. Preferably this seal will be an intumescent seal. Where an intumescent seal is used, the material of the post is more preferably a fire retardant material, or a treated material for making it less combustible than the raw material.

Preferably a post which forms a part of the jamb is provided at the closed door edge side of the door frame, i.e. spaced across the doorway from the jamb column. Preferably it has at least one groove in its profile for receiving a seal. The seal can provide a draught seal or it can have the function of preventing the slamming of the door into the jamb, or both.

Preferably the post which forms the closed door edge jamb has a flat surface for receiving a finishing surface flush against it.

Preferably the upper and lower supports are formed from an extruded profile of metal. In another embodiment it might be fabricated—for example with an extruded part and possibly a secondary part riveted or welded thereto.

Preferably the width of the upper and lower supports is such that they are similar to the size (width) of a cavity within an internal wall partition—typically 4 inches or 10 cm in the UK. Other sizes are also possible, and the wall can be customised to suit.

Preferably the upper and lower supports have a groove present along the axis where screws or nails are to be secured to function as a guide point and reduced slipping of the tip of the fastening hardware—similar to the column above.

Preferably the grooves have tapered holes predrilled at pre-defined distances along the support. Those distances may be so as to provide predefined locations for fitting the columns (or pairs thereof).

Preferably a rail may be mounted within the channel of the upper support for a part of the sliding mechanism of the door.

Preferably a rail may be mounted within the channel of the lower support for a part of the sliding mechanism of the door.

Preferably a raised ridge, or other locating points, may be within the channel of the upper or lower supports for mounting its rail therein.

Preferably the or each rail has ridges or grooves which locate within the channel, e.g. on the raised ridge, or other locating points of the channel of the upper or lower supports.

If the means for location, such as the ridges or raised ridge, or other locating points are centrally positioned in the channel, this allows the rail likewise to sit centrally, thus reducing the likelihood of fouling of the door against the posts as it slides through the channel.

Preferably there is a lintel provided at the top of the frame which locates within a channel of the upper support.

Preferably the lintel has at least one groove facing the door for a sealing member to be secured within. The sealing member can be a brush, an intumescent seal, both, or any other type of seal.

Preferably the lintel has a flat inner surface for a finishing lintel to be secured against.

Preferably the lintel provides a surface for a wall partition panel to be seated against.

The various components of the frame are preferably each of a one-piece construction along their lengths. However, it is plausible for the components, and particularly the lintel or jambs, to be formed from multiple posts, extrusions or panels, especially if a single longitudinal component load bearer (such as the columns or the upper or lower supports) is located underneath it for providing the structural rigidity.

Preferably the finishing surfaces for the door frame are formed from extruded profiles.

Preferably the finishing surfaces are shaped to fold around the inside door frame and outer wall surface.

Preferably the outer wall surface of the finishing surfaces sits against an unfinished surface of a wall, to allow finishing techniques such as plastering or jointing material to be applied onto the frame to produce a flush finish with the adjoining wall. The installed frame portion thus allows the finished wall to transition up to the door with no broken surface and maintain a uniform look with minimal gap from the wall to the door with no requirement for an architrave. However, conventional architrave finishes can also be applied instead and also alternative finishes such as providing a frame with a shadow gap.

According to a second aspect of the present invention there is provided a base bracket for a sliding door comprising
a floor plate with a fixing member fastened to it;
a wheeled bogie fastened onto the fixing member; and
a spring around the fixing member and positioned between the floor plate and bogie.

Preferably the fixing member is an elongate member. More preferably it is a fixing screw or a fixing bolt or a fixing stud.

The base bracket may be provided along with the sliding door, or a base rail for the sliding door, the bogie being for fitting within a longitudinal channel in either the base of the sliding door or in the base rail.

Preferably the wheels of the bogie sit within the channel with their axis of rotation parallel to the sides of the channel.

Preferably the channel is slightly wider than the wheels which sit within it.

Preferably the wheels may roll within the channel.

Preferably the bogie is rotatable around the fixing member.

Preferably the spring is a torsion spring which applies a rotational force upon the bogie within the channel, so as to apply a force on either side of the channel through the wheels of the bogie. As a result, in use, the sliding door is resiliently restrained in its lateral direction. This also ensures that the wheels on either end of the bogie are in contact with the channel, thus helping to centralise the door in the channel for reducing incidence of door jamming when the door is slid between open and closed positions.

According to a third aspect of the present invention there is provided a sliding door mechanism comprising a rail along which the door can slide, the rail comprising a groove along at least a part of the length of the rail;

the mechanism further comprising:

a stop for the sliding door, the stop comprising a strip that fits within the groove of the rail; and

a stopping member positioned at or near an end of the strip;

wherein the strip does not prevent the door from sliding along the rail; and

the stopping member which is positioned at or near the end of the strip extends transversely away from the strip into a position which limits the sliding of the door along the rail so that the stop prevents sliding of the door past a certain point along the rail.

Preferably the strip is formed from metal.

Preferably the stopping member is a wedge.

Preferably the length of the strip is variable, e.g. by cutting it to a desired length.

Preferably there is a screw hole provided in the strip to allow fixation of the strip in a desired position within the groove.

According to a fourth aspect of the present invention there is provided a method for mounting a stop for a door slide mechanism on which a sliding door may hang, comprising:

providing a rail along which the door slide mechanism can slide, the rail having a groove in its length;

providing a strip that will fit within the groove, the strip having a stopping member positioned at or near an end of the strip;

feeding the stopping member end of the strip into or along the groove of the rail, the length of the strip being fed being dependent on the desired position of the stopping member within the rail, that desired position being the position for stopping the sliding door's extent of movement along the rail (the door slide mechanism is arranged such that it cannot slide past the stop).

Once fitted in a cavity of a wall—for a pocket door arrangement—the rail is generally only accessible from one end, so a feedable stop is beneficial.

Preferably the rail is mounted within a wall cavity. Since the stopping member will be mounted within the sliding door pocket, this strip allows the stopping member to be mounted after the walls have been installed.

Preferably the stop is secured in position by a screw or nail through a screw hole which is provided in the strip to allow fixation to prevent further movement once positioned in the groove.

These and other features of the present invention will now be described in further detail, purely by way of example, with reference to the accompanying drawings, in which:

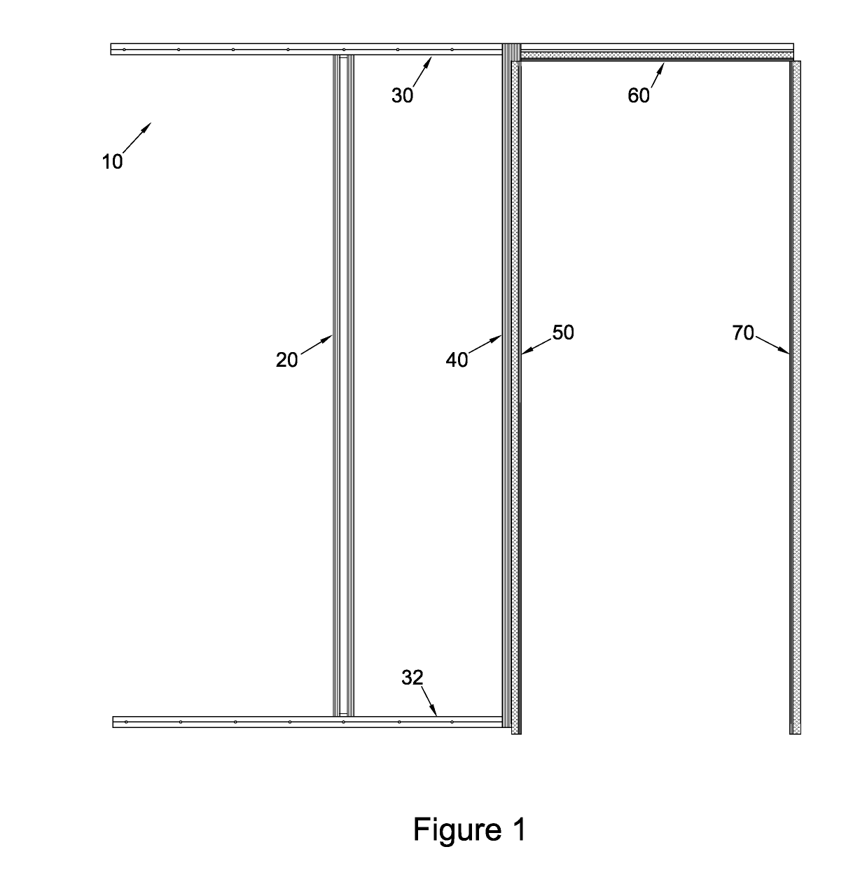

FIG. 1 shows a side view of an assembled frame of the present invention;

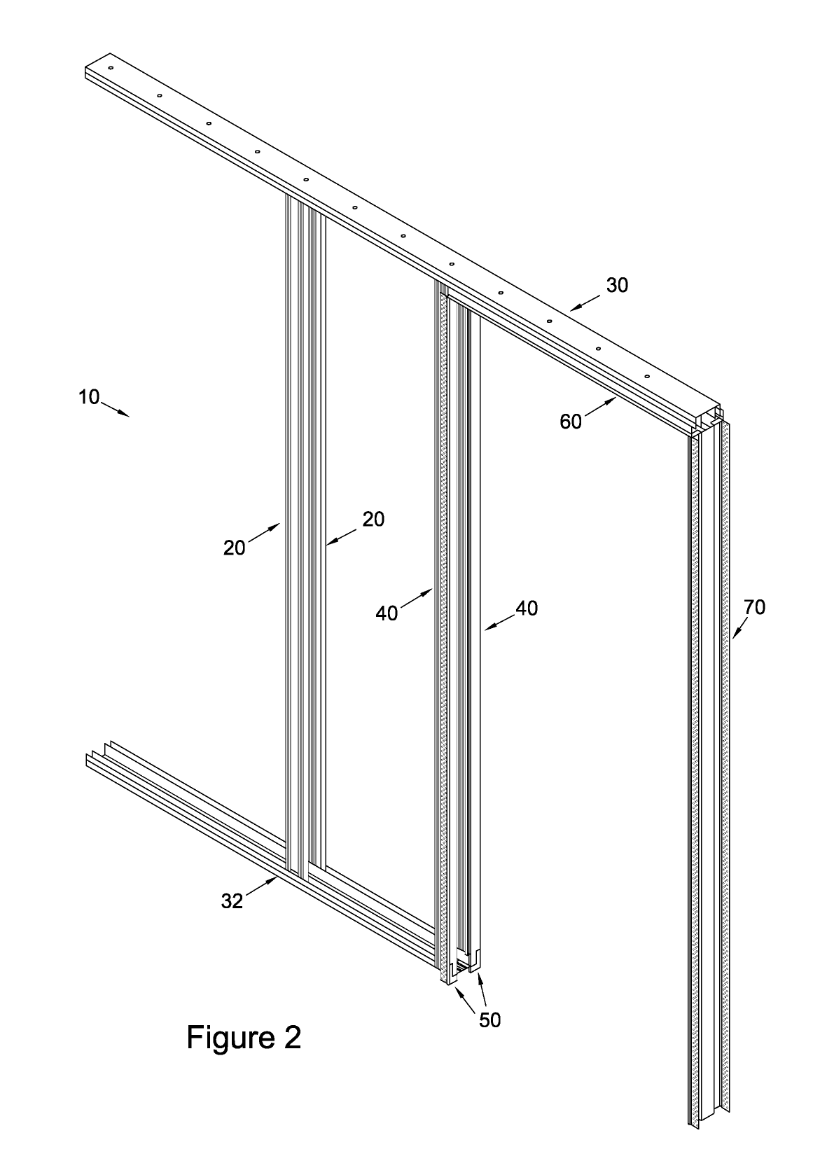

FIG. 2 shows a perspective view of the assembled frame as shown in FIG. 1;

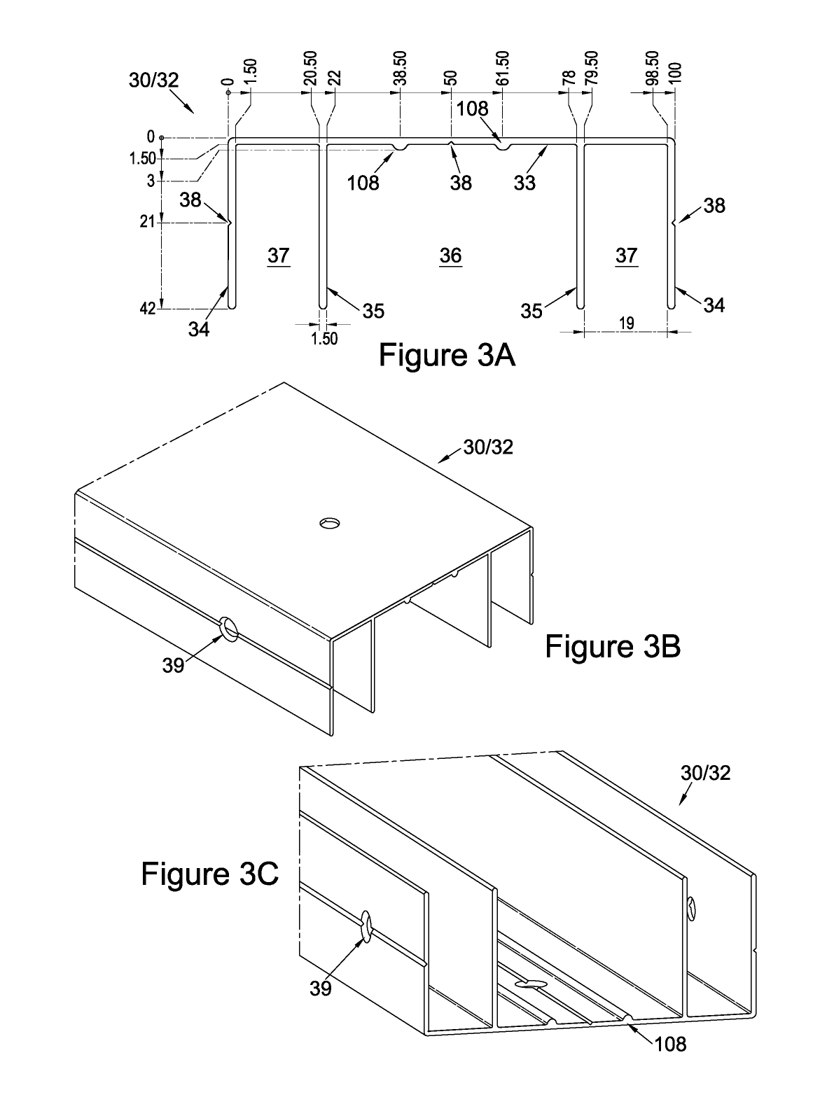

FIGS. 3A, 3B and 3C show a plan view, an elevated top view and an elevated underside view respectively of the upper or lower support of the present invention;

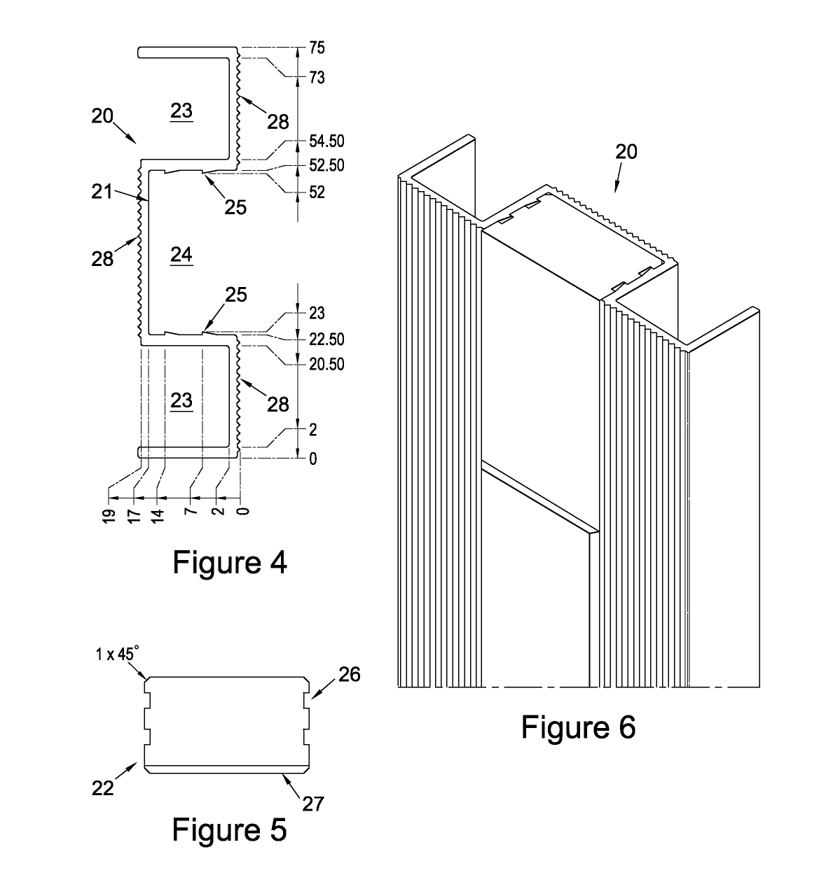

FIG. 4 shows a plan view of the column (a vertical post) as seen in FIG. 1;

FIG. 5 shows a plan view of a solid beam;

FIG. 6 shows a side elevated view of the column of FIG. 4 and the beam of FIG. 5 in an assembled configuration;

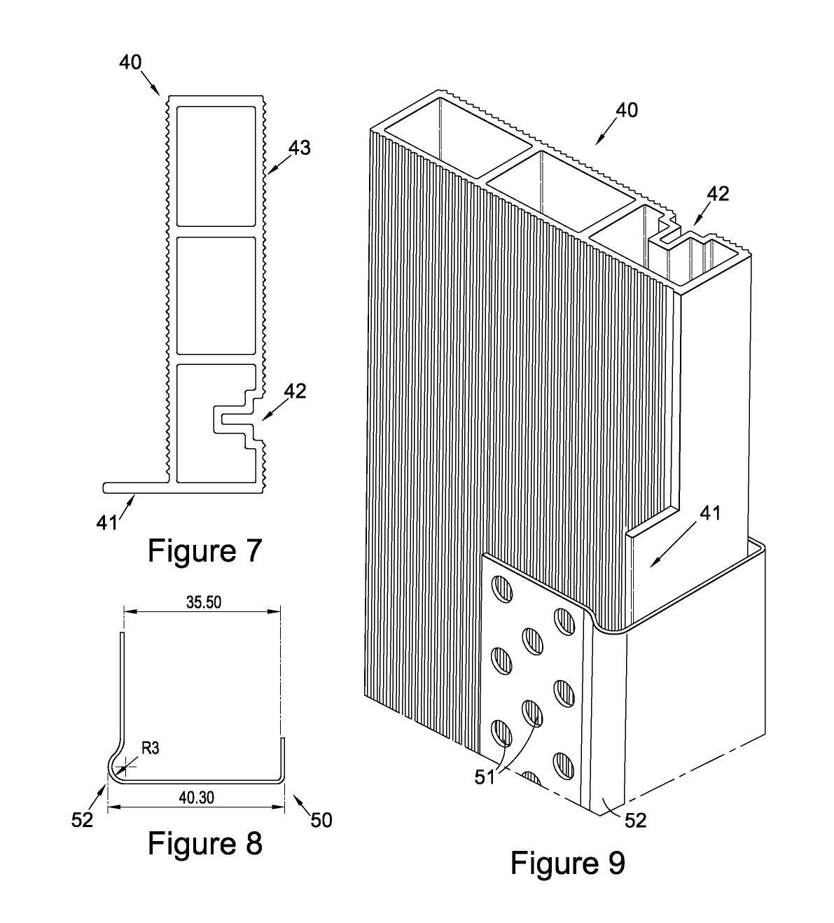

FIG. 7 shows a plan view of a jamb column as shown in FIG. 1;

FIG. 8 shows a plan view of a finishing jamb as shown in FIG. 1;

FIG. 9 shows a side elevation view of the assembled jamb post featuring the jamb column of FIG. 7 and the finishing jamb of FIG. 8;

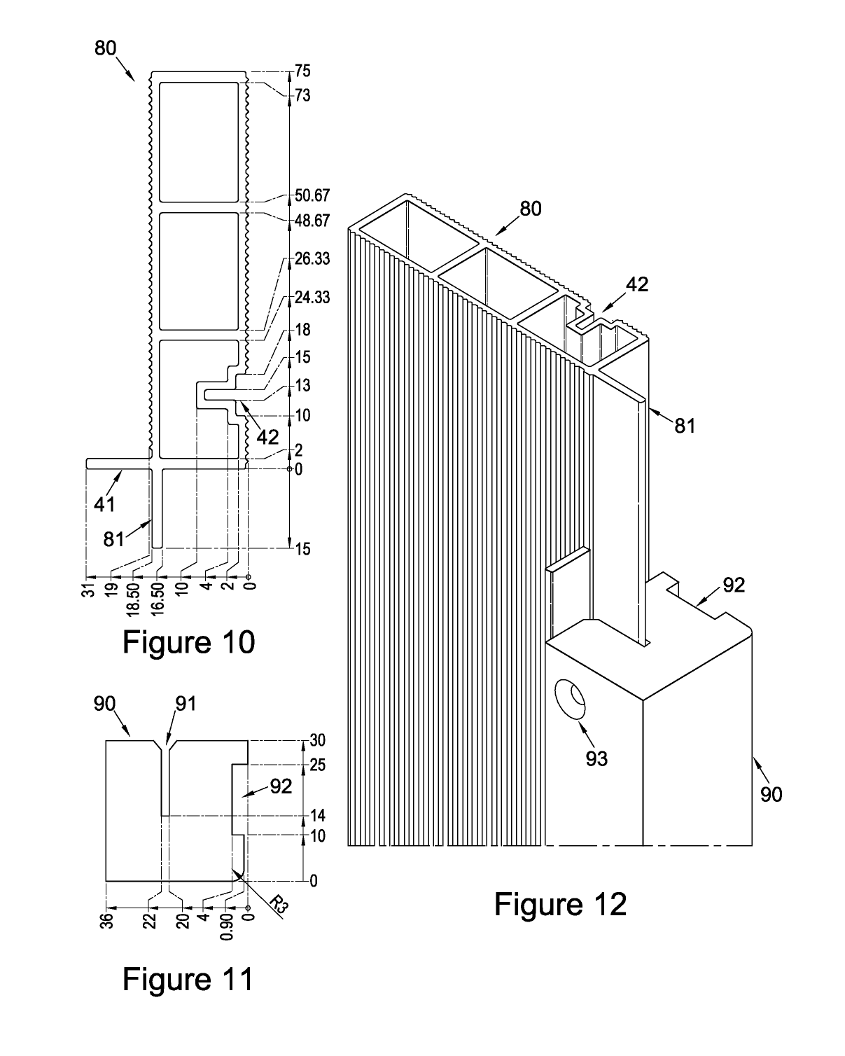

FIGS. 10 to 12 show an alternative arrangement for the jamb post according to the present invention;

FIG. 10 shows a plan view of an alternative arrangement for a jamb column;

FIG. 11 shows a plan view of a jamb beam to attach to the jamb column of FIG. 10;

FIG. 12 shows a side elevated view of the assembled jamb post featuring the jamb column of FIG. 10 and the jamb beam of FIG. 11;

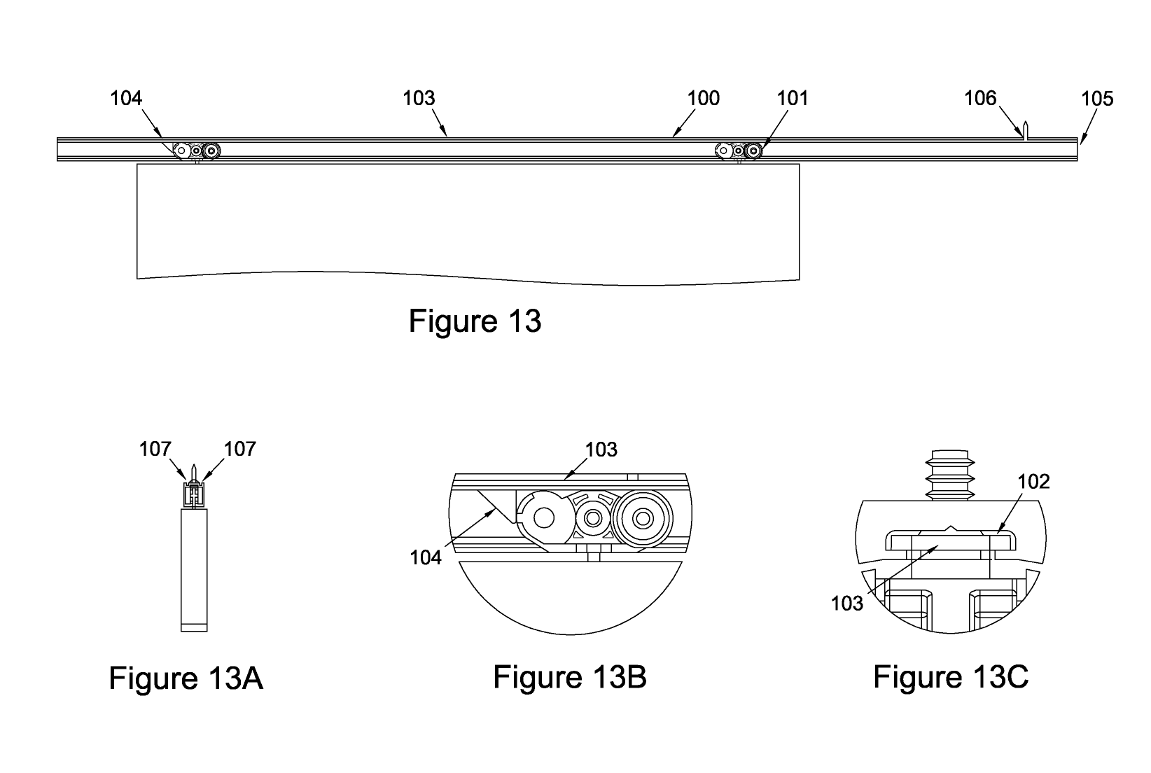

FIG. 13 shows a side view of a sliding door track or rail according to the present invention;

FIG. 13A shows a front view of the track of FIG. 13;

FIG. 13B shows a side view of another detail of the track of FIG. 13;

FIG. 13C shows a front view of a detail of the track of FIG. 13;

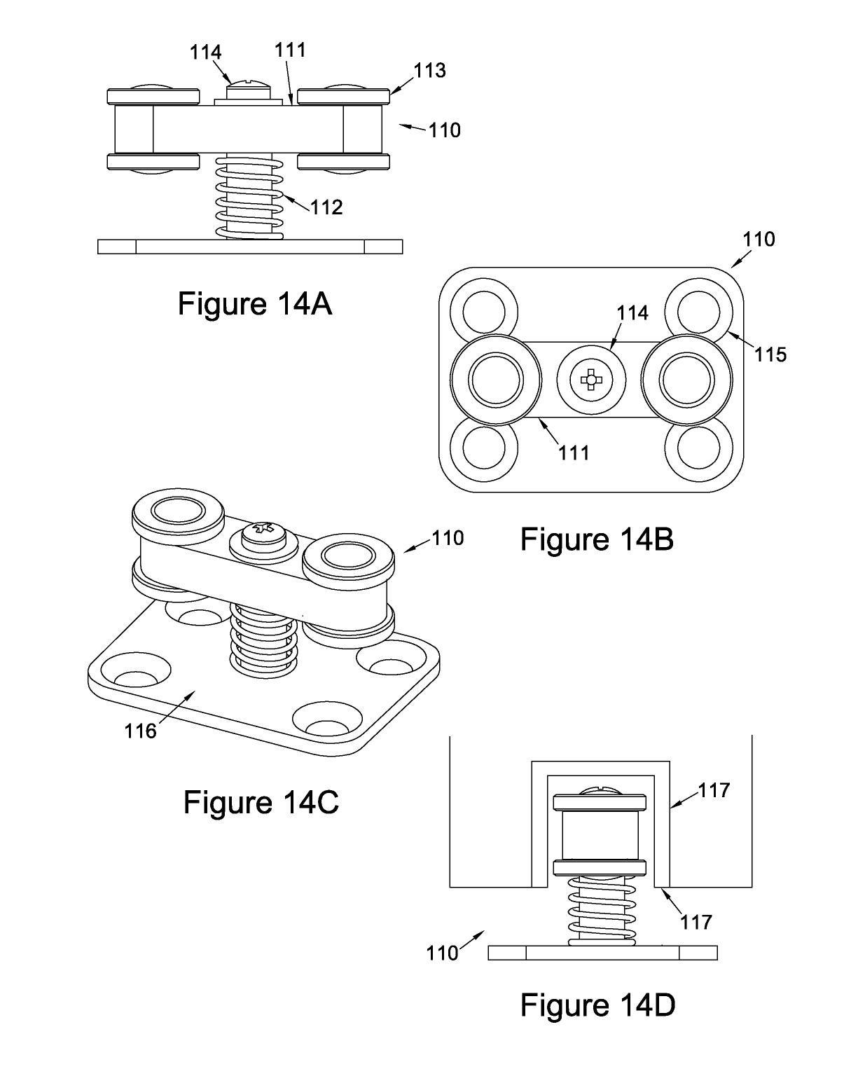

FIGS. 14A to 14D show side, plan, perspective and front views respectively of a base bracket for guiding a sliding door according to the present invention;

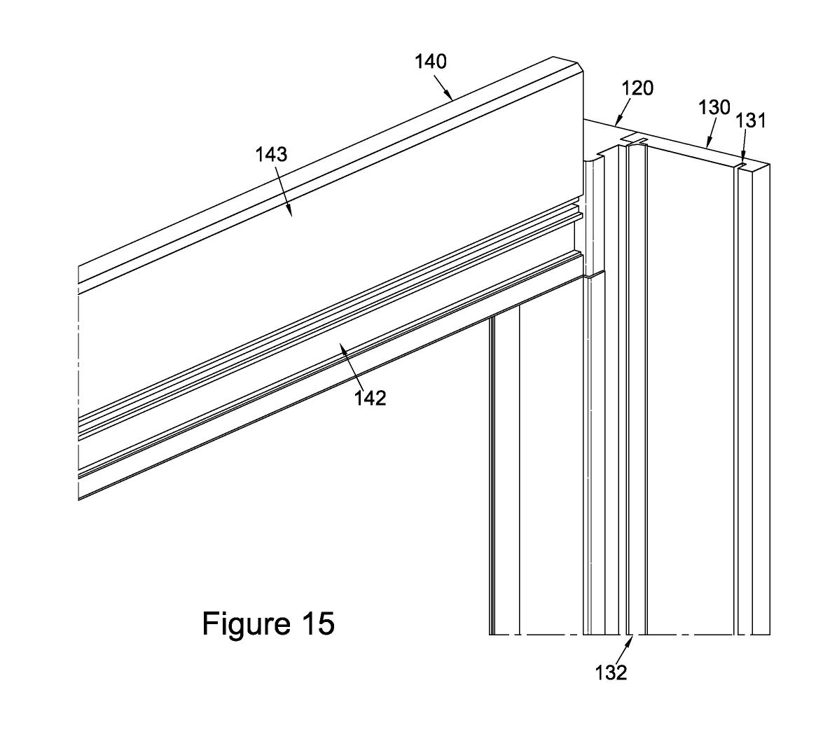

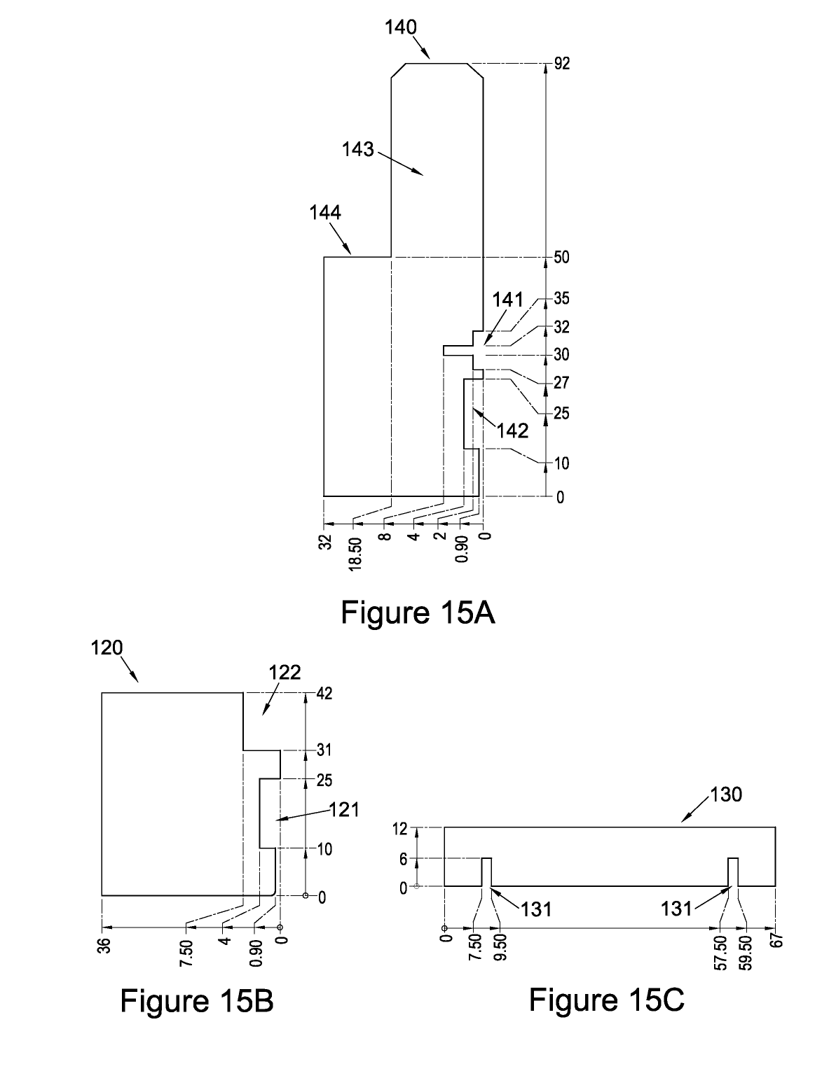

FIG. 15 shows an elevated view of the closing jamb, sealing and lintel blocks of an alternative arrangement according to the present invention for the sliding door frame from an inside view;

FIG. 15A shows a plan view of the lintel block of FIG. 15;

FIG. 15B shows a plan view of the closing jamb block of FIG. 15;

FIG. 15C shows a plan view of a sealing block as shown in FIG. 15;

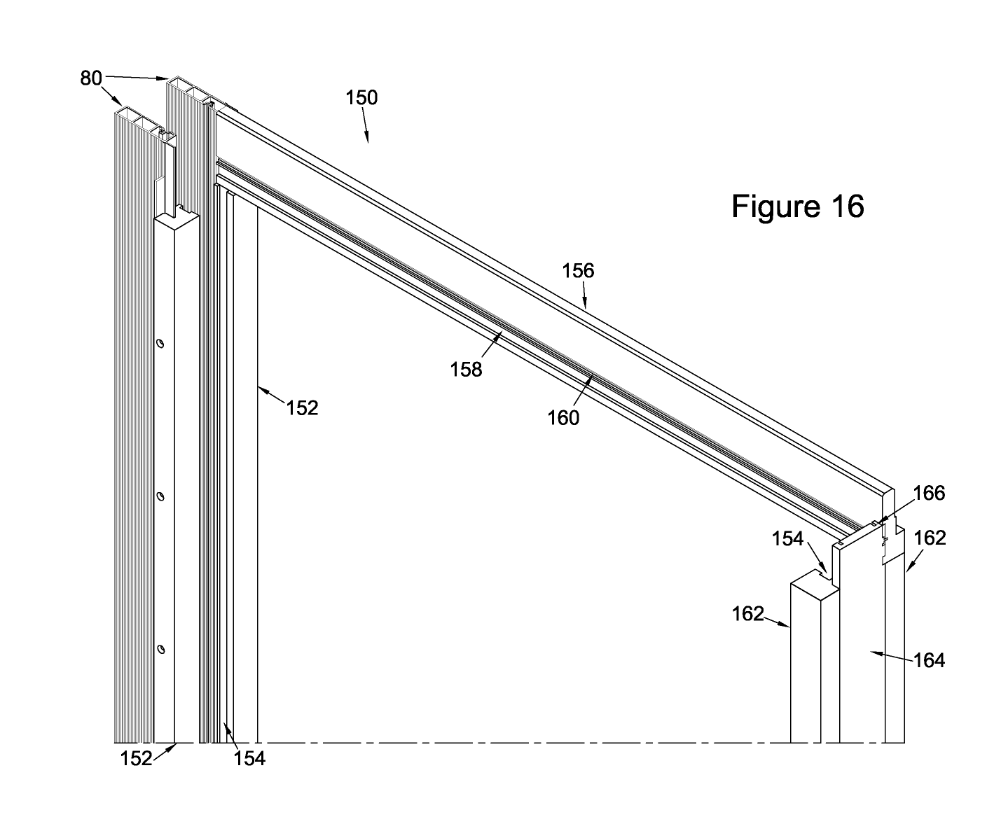

FIG. 16 shows a perspective view of an alternative arrangement for a jamb and lintel frame according to the present invention;

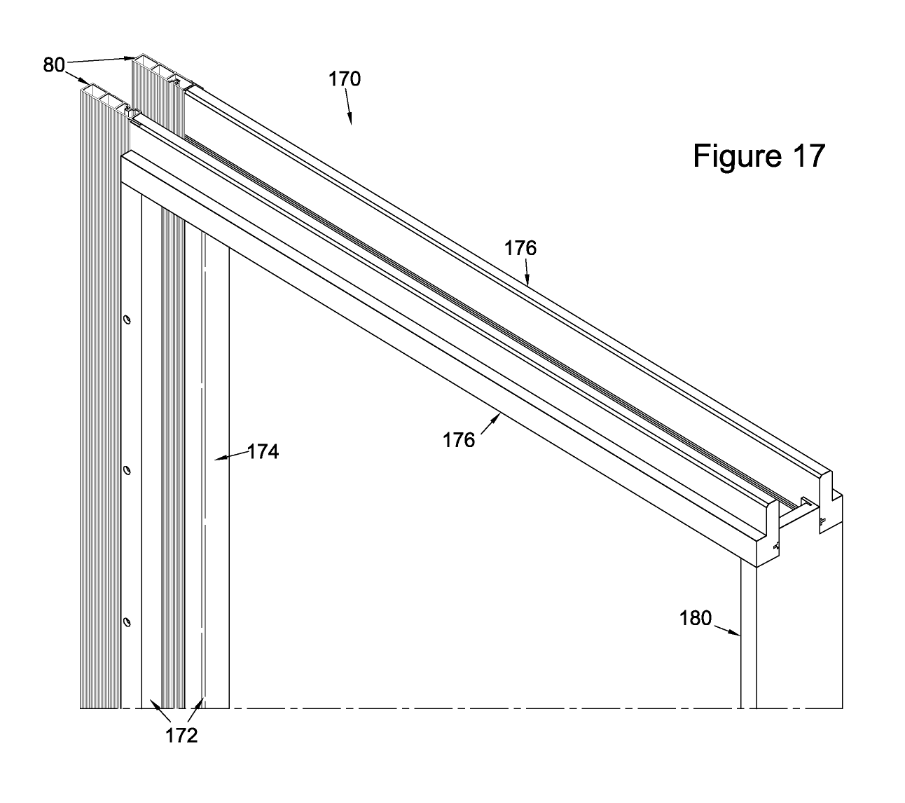

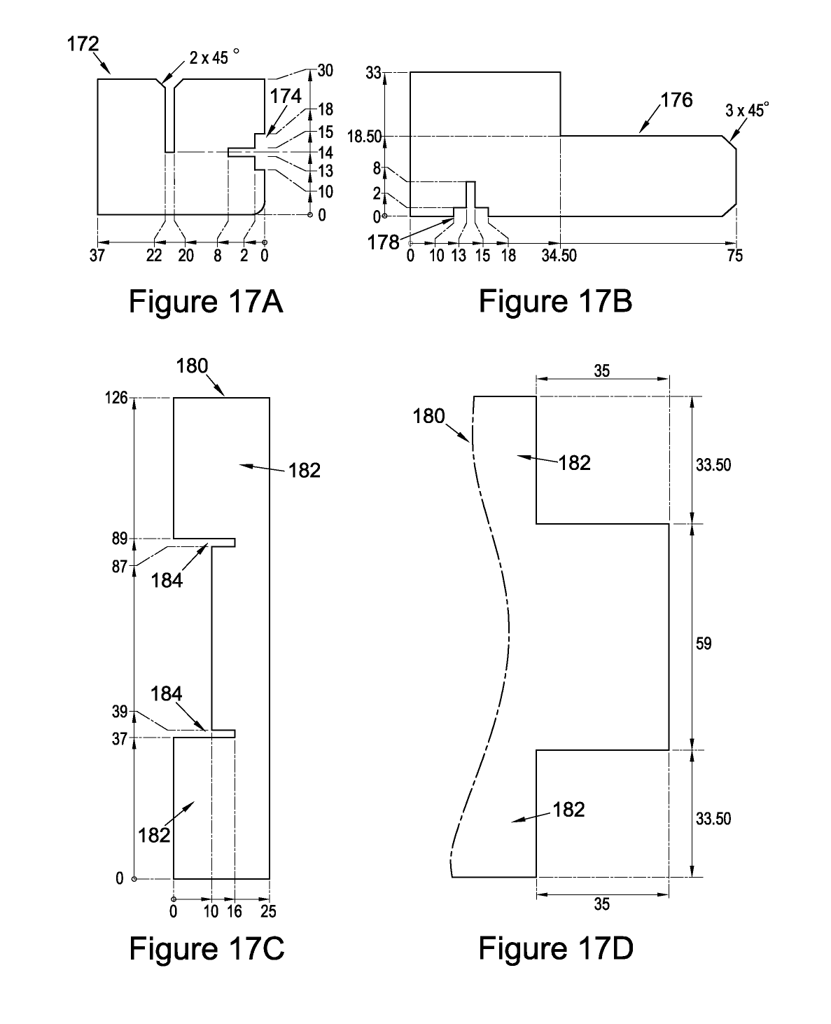

FIG. 17 shows a perspective view of an alternative arrangement for a jamb and lintel frame according to the present invention;

FIG. 17A shows a plan view of a beam block of FIG. 17;

FIG. 17B shows a plan view of a lintel block of FIG. 17;

FIG. 17C shows a plan view of a seal block of FIG. 17;

FIG. 17D shows a front view of a seal block of FIG. 17;

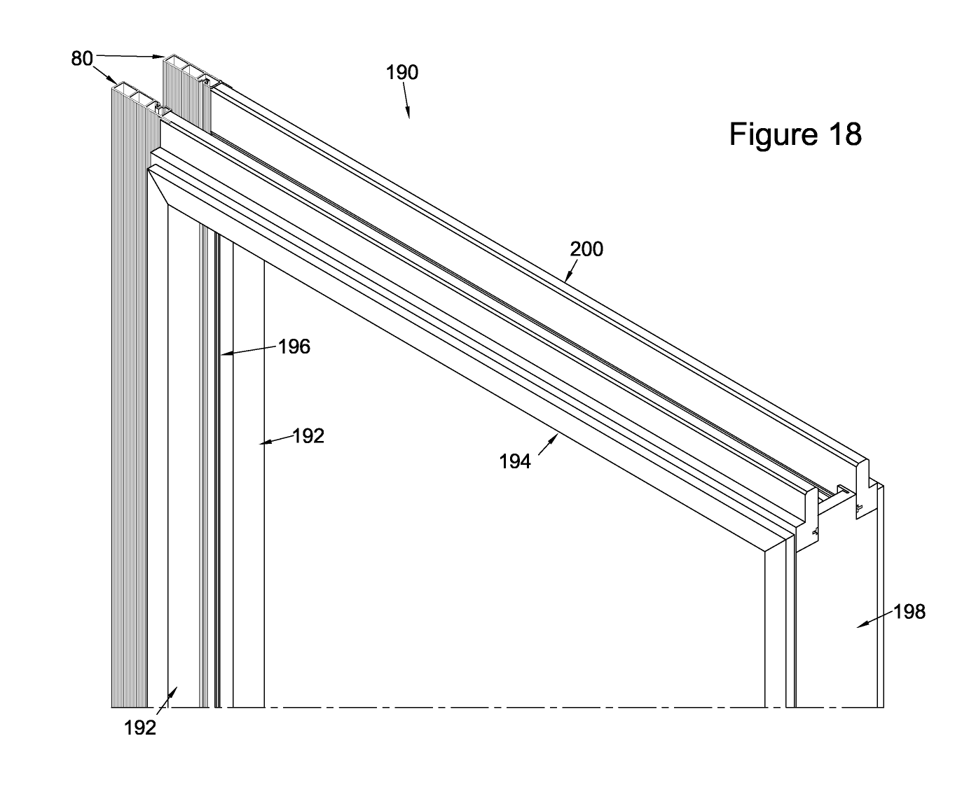

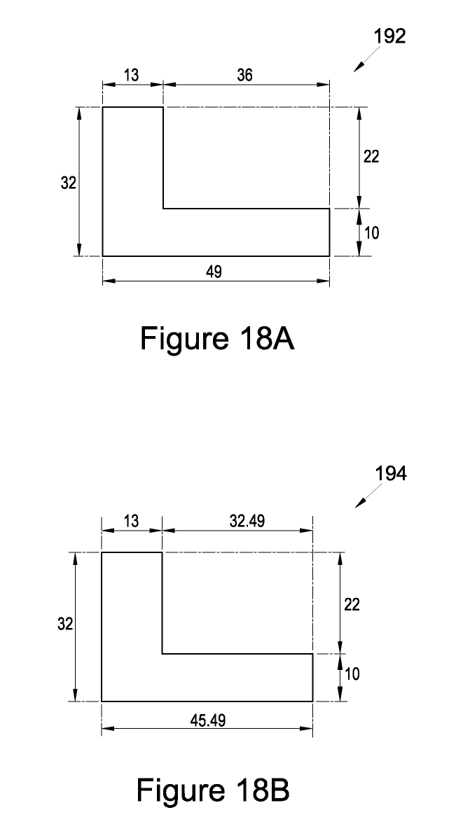

FIG. 18 shows a perspective view of an alternative arrangement for a jamb and lintel frame according to the present invention;

FIG. 18A shows a plan view of a finishing jamb of FIG. 18; and

FIG. 18B shows a plan view of a finishing lintel of FIG. 18.

Referring first of all to FIG. 1, an example of a support frame for a sliding door 10 is shown. In this embodiment, vertical columns 20, a top support 30, a bottom support 32, jamb columns 40 and a jamb post 70 are shown. These components are comprised as follows:

The top support 30 and the bottom support 32 extend horizontally in a spaced apart manner, and are joined by a pair of vertical columns 20 and a pair of jamb columns 30 along their lengths. In FIG. 1, only one of each pair of columns is visible since the view of the other ones of the vertical columns which form the pairs is obscured by the visible ones. The perspective view of FIG. 2 has a clearer view of the pairs.

It should be noted that only one pair of vertical columns 20 is shown in the example, the other pair being the pair of jamb columns. However, a plurality of pairs of vertical columns 20 may be used in other embodiments, as appropriate for the size or design of the frame required (this is a single door arrangement for a 75 cm door—if a double door, then a mirrored arrangement could be at the opposite side of the frame, and if it was instead for a wider door, a second/third etc. pair may be on the one side).

The pair of jamb columns 40 is also mounted vertically between the top support 30 and the bottom support 32. The pair of jamb columns 40 form a side jamb of the door frame.

In the example shown in FIG. 1 only one pair of jamb columns 40 will be required. However, there may be situations where more than one pair of jamb columns are used on a sliding door frame such as where multiple doors share the same frame.

On each individual jamb column 40, there is mounted a finishing side jamb 50. It is the pair of finishing side jambs 50 which forms the visible internal frame of the door.

The particular finishing jambs in this example form a frameless finish on the outer wall surface of the sliding door frame.

Also visible is one of the finishing lintels 60 which, when the door is open, forms the top edge of the door frame.

Forming the opposing side jambs of the door frame is side jamb 70. This is mounted on the side of the frame which is furthest from the pocket formed by the vertical posts 20. As such, side jamb 70 need not be a pair since no door will need to pass through it.

FIG. 2 provides an alternative view of the pairs of jambs and posts.

Referring next to FIGS. 3A, 3B and 3C, a detailed view of the top support 30 or bottom support 32 is shown. Apart from their lengths, the top support and bottom support are identical in this embodiment. Therefore the top support 30 can simply be turned over to illustrate the bottom support 32. Their lengths differ, however, so they are not interchangeable, unless cut to length from a longer member. Given the similarities in their structure, the following description of the top support 30 applies mutatis mutandis to the bottom support 32.

In FIG. 3A we see a profile of the top support 30. This comprises of a base 33 with four extruded flanges, all arranged perpendicular to the base, and extending in the same direction therefrom, and with the same length. The outer flanges, or the side extrusions 34, are at either end of the base 33. This forms a peripheral U beam for the profile. The middle flanges or middle extrusions 35, which extend in the same direction from the base 33 as the side extrusions 34, are located at points that are equidistant to the relevant side extrusions 34. This forms an additional U-channel within the larger peripheral U-channel formed by the side extrusions and base, which additional U-channel is located in the middle thereof. As a result as seen in FIGS. 3B and 3C, the top support has three parallel-walled channels where the side extrusions 34 and middle extrusions 35 form smaller side channels 37 than the additional U-channel 36.

The side channels 37 are for receiving the pair of vertical columns 20 and jamb columns 40 when forming the sliding door frame 10.

On the outer wall of the U-channel formed by the side extrusions 34, there is a groove 38. In this embodiment this groove 38 extends down the complete length of the top support 30. Spaced along this groove are countersunk holes 39. These holes 39 are used for attachment of the posts into the channel 37, e.g. using self-tapping screws.

In FIGS. 3A to 3C, the groove 38 is shown to be a triangular notch with a wide open face narrowing to a point. This groove 38 can be used for the location of screw or nail points to avoid slipping when joining the columns to the top support 30.

If countersunk holes 39 were not adequately positioned for the best support of the columns, then the groove 38 provides a convenient starting point for drilling or tapping a new hole within the top support 30 with reduced risk of vertical movement of the drill head (or other undesired slippage).

Although in this example the groove 38 is shown to be continuous, it may be of a broken line or even a different shape.

The countersunk holes 39 can be used for mounting the top support 30 by use of nails or screws through the holes onto a suitable surface. The holes are countersunk such that the head of the screw or nail does not interfere with the sliding mechanism in the case of a top support 30 or the actual door which slides in the case of a bottom support 32.

The width of the top support 30 is such that it matches the width of a beam usually used when forming a partition in a wall—such as in stud-walls. This allows the installation of a sliding door within a pocket of an existing partition, without the need for the removal of all the covering of a partition. However, different sized profiles may be provided depending on the size of the partition.

Although a profile for the top support 30 or bottom support 32 has been described with certain sized channels, it would be possible to have different sized channels. For instance, a deeper channel may provide more support, or perhaps a thinner channel is sufficient to hold the frame.

In FIG. 6 an assembled vertical post 20 can be seen. This is formed from the vertical column as shown in FIG. 4. The vertical column has a profile formed by two U-beams which are joined by a straight web 21 extending from a free end of each U-beam in a perpendicular direction away from the U-beam. This forms a vertical profile with three channels: two smaller outer channels 23 formed from the two original U-beams and a larger middle channel 24. The smaller channels 23 share a wall each with the middle channel 24.

The middle channel has its open edge at the opposite side to the small channels 23. Due to the shape of this vertical profile, it in itself forms a relatively rigid shape in terms of longitudinal flexing.

In FIG. 5, an example of a beam 22 is shown. This is mostly rectangular in shape with chamfered edges. In addition, it has several notches 26 cut out on the sides which extend down the length of the profile. This beam 22 is shaped such that it fits within the middle channel 24 of the vertical profile of the column 20. Within the middle channel 24 are correspondingly spaced wedges 25 extending from the wall of the U beam. The wedges 25 are aligned with the taper such that the beam 22 can be relatively easily pushed into the middle channel 24, but also such that the removal of the beam from the channel will be difficult, as a result of the distal flat face of the wedges 25 exerting a force against the opposing sides of the notches 26 of the beam. Thus, the beam is constrained within the vertical profile of the vertical post 20 by the wedges and notches.

It should be noted that in this embodiment the beam does not have a uniform profile throughout its length. The free edge 27 of the beam normally sits slightly proud of the middle channel 24 on which it sits. However, a portion of the end of the beam (i.e. the top and bottom once it is installed) has the free edge 27 cut or narrowed such that it sits flush at those ends within the middle channel 24, rather than extending slightly proud thereof. This feature allows the top and bottom of the vertical post 20 to sit within the respective side channel 37 of the top and bottom supports 30 with the front and back edges of the beam 22 and vertical profile both touching the sides of the side channel 37. This ensures a sturdy fit and decreases movement of the frame in use due to the greatest amount of surface area being in contact with one another.

The purpose of the free edge 27 of the beam 22 elsewhere sitting proud of the middle channel 24 for the vertical post is to allow a straightforward connection (e.g. by screwing or nailing or gluing) of a wall material (such as a plasterboard) to the beam 22. Because the free end 27 sits slightly proud, if the material of the beam was to shrink when compared to the vertical profile, there would be no resultant bowing of the wall material (which is attached to the beam 22). Bowing due to the wall material overlying the top and bottom support 30 is also prevented—the top and bottom support, of course, fits over the ends of the columns/beam.

The vertical post 20 should be made of a relatively rigid material, although it is advantageous for the material to also be lightweight to assist with the assembly of the sliding door frame. A material such as plastic could be used, although this can become brittle over time, or can be difficult to screw into. As such it could fail after repeated opening and closing of the door. It would be advantageous if material resilient to cracking was chosen. Therefore, metal or metal alloys may be the preferred option for the column 20, whereas wood may be preferred for the beam 22.

The size of the door frame often varies from installation to installation, depending on the distance of the framework that forms the wall partition. Therefore, the columns and supports might be supplied in longer lengths than required so that they can be cut down to length as required. However, it is known that the cutting of metals can be difficult, especially in the case of steel or similar alloys. Cutting disks and grinders may have to be utilised.

Use of such tooling, if available, may not be problematic if installing a sliding door frame in a private residence. However, as part of larger development work, where other services such as gas is being installed concurrent to the interior work, there may be restrictions to any work which may be a fire risk—and grinding is often one of these restricted activities. Therefore, there are benefits in the use of non-ferrous materials for the columns or supports since then the likelihood of sparks from cutting is greatly reduced. Such non-ferrous materials include aluminium. Timber is also thus still suitable for the beam.

Some of the outer surfaces of vertical profile 21 are corrugated 28. This can be seen in FIGS. 4 and 6. These corrugations provide additional bending strength, without the dramatic weight increase of a generally thicker material. In addition, the corrugations aid with the cutting of the columns to length since the apexes of the corrugations will quickly be removed with a cutting implement, thus allowing a quick keying in of the cutting implement, thus reducing or preventing slipping of the cutting implement (which may otherwise disadvantageously alter the angle of the cut or the resulting length of the column). It also allows a bonding agent to be used for attaching a plasterboard, for example, to the columns—the corrugations provide a key for the bonding agent—which would otherwise be difficult to get to adhere to the metal.

For the purpose of installing the beam 22 and vertical column 20 into the relevant channel of the top support 30, the beam 22 must sit flush within the middle channel 24 of the vertical column 20. Although the beam 22 may be pre-profiled for that purpose (e.g. if provided for a door of a known height), if the beam 22 must be cut to size on site, it may be necessary to chisel the beam material from the top or bottom thereof to ensure it will sit within the channels of the supports. By being made of wood, or another fibrous material, this is readily achievable. This is in addition to the material of the beam, i.e. wood or other fibrous materials, being ideal for screwing or nailing a wall surface into.

The jamb column 40 is shown in FIGS. 7 and 9. FIG. 7 shows that the profile for the jamb column consists of three rectangular shape boxes which are extruded. These boxes will form a very rigid structure—resisting bending and twisting—in addition to being lighter in weight than a solid structure.

On the edge of the jamb column 40 (which faces the inner edge of the door) there is an extrusion 41. This extrusion 41 does not extend throughout the length of the jamb post 40, but at the extremities of the jamb post, i.e. the top and bottom, the extrusion 41 is not present to allow the jamb post to fit into the top support 30. The purpose of the extrusion 41 is to further increase the rigidity of the jamb column 40. The extrusion 41 increases the dimension of the column in a direction normal to the plane of the front or rear of the door and therefore provides a support to resist bending moments in this direction. The allowable space for a jamb column 40 is defined by the space of the partition of a wall, where a door and two columns have to fit within this cavity. As such, to ensure the columns do not encroach into the room area, the columns must be narrow (i.e. when considered as a pair and with a door, no thicker than the pocket width) when viewed from the door edge. The extrusion 41 is able to circumvent this narrow requirement by forming part of the inside door edge since the wall material and jamb will extend this far and the extrusion will not be unsightly. The extrusion 41 will also provide an edge to which the wall material (which forms the sliding door pocket) is fitted. This means that the other side of the extrusion 41 will provide a flat surface for a finishing jamb for the inner edge of the door frame. The features of the extrusion 41 assist with the installation of the door, since the jamb post 40 will be more rigid and easily moved into position, along with the plasterboard (or other material) not having to be cut with a perfect edge.

In FIGS. 7 and 9 there is shown a brush slot 42 which extends along the length of the jamb column 40. This brush slot 42 allows for the insertion of a brush, or other sealing member, in the jamb column 40. This brush faces the sliding door and provides a seal or end-closure to ensure the internal frame structure (which may be less aesthetically pleasing) is hidden from view. It can also provide a seal or draught-reducing benefit for when the door is closed to reduce or prevent the passage of sounds or odours or draughts around the door. The brush also provides a dampening effect, reducing the rattle of the door as it slides in a rail, and also the rattle of a static door due to draughts or pressure differences in adjoining rooms.

The finishing side jamb 50 as shown in FIG. 8 and FIG. 9 forms the final finishing surface which is visible on the inside of the door frame. The profile of the finishing side jamb 50 is shaped such that it sits around the jamb column 40 and on top of the wall material (not shown) which abuts against extrusion 41.

In the case of a plasterboard wall material, it may be adhered to the column 40, e.g. using a bonding agent—corrugations are again provided to assist with that, and the single side jamb may affix to it through holes 51 where screws or nails may be used.

The raised corner in the profile of the finishing side jamb 50 allows for the application of plaster on top of the plasterboard and this surface of the finishing side jamb 50.

For an architrave free finish, the plaster would not be applied more deeply than the peak of the raised corner 52 thus providing a flush surface to the door and a finishing side jamb 50. This provides a frameless door effect with a non-visible front facing jamb. The holes 51 have an additional feature that they assist with the adhesion of the plaster which is applied to the jamb and the plasterboard since it provides a three dimensional shape or element for the plaster to adhere against.

Since the jamb post 40 may have to be resized on site prior to installation, again a non-ferrous metal would be advantageous. However, in some embodiments the finishing side jamb 50 may be pre-sized since doors are often of a standard size. As such, the material used for the finishing side jamb 50 may be ferrous.

Note too that the finishing side jamb 50 may even be provided in other materials, including plastic, and it is desired for it to have an aesthetically pleasing finish at least on its end face that won't be covered in plaster—thus being pre-finished.

FIGS. 10 to 12 show an alternative arrangement, still according to the present invention, for the jamb column 40. In this embodiment, the jamb column or jamb post 40 would not form the final surface to which the finishing jamb would attach. Instead a block beam 90 would be attached to the jamb end of the block post 80 to provide the flat surface for the jamb to sit against. The block post 80 differs from the jamb post 40 in that there is an additional extrusion 81 extending in the door frame direction, i.e. perpendicularly to the extrusion 41. This additional extrusion 81 is to allow a block beam 90 to attach to it.

Referring to FIG. 11, the profile of the block beam 90 is shown. Here this is a mostly rectangular block which has a notch 91 extending throughout its length, which is shaped such that the notch houses the additional extrusion 81 of the block post 80. This ensures that the block beam 90 is held in the correct position when it is mounted against the block post 80 to prevent additional movement.

The block beam 90 also has a wide slot 92 cut in the face which will face the door, i.e. the same side as the brush slot 42. The purpose of this slot can be for an additional seal to increase the sealing of the door. This seal could be to prevent excessive noise or light around the door or, where regulations require it, to provide an element of fire retardation to the door. In the case of fire retardation, an intumescent strip may be used where, when exposed to heat, the strip will expand. Where there is a fire, the seal will prevent the passage of smoke through the closed doorway. Since the intumescent strip will only expand under heat, the brush strip held in brush slot 42 will provide some prevention of a passage of smoke around a closed door in the situation where the heat of a fire is yet to reach the intumescent seal to cause it to expand.

Such strips, and grooves therefor, can likewise be provided for the other embodiments.

Within the block beam 90 screw holes 93 may be provided to allow the block beam 90 to fasten more securely against the additional extrusion 81. These screws may not necessarily pass through additional extrusion 81 but may be blunt head and sized such that they constrain block beam 90 to block post 80.

If desired, a finishing jamb such as the single side jamb 50 will then provide the visible inner surface of the door frame. However, the dimensions of the single side jamb 50 as used for the jamb post 40 may have to be changed to take into account the block beam 90. For instance, the front facing, hidden, surface will need to be longer to cover the jamb post.

To complete the door frame, as shown in FIG. 1, there is provided a top lintel 60 which is fastened around the side channel 37 of the top support 30, thereby hiding the side extrusion 34 and the middle extrusion 35 from view when the top support 30 is viewed from inside the door frame (i.e. when the door is open and the door is sat within the pocket).

Since the side jamb 70 does not require the door to slide through it but instead provides a stop for the door, it can be formed as a single piece and not a pair as seen with the finishing side jambs 50.

Although, as seen in FIGS. 1 and 2, finishing jambs or lintels which affix directly to the walls are provided, there are other possibilities available such as using a lintel or jamb which the finishing surface attaches to. These will be discussed in detail later.

FIG. 13 shows the track 100 which carries a mechanism which allows the sliding door to travel along the channel. This track is affixed to the middle channel 36 of the top support 30. The sliding door is affixed to the door carrier 101 which slides inside the track 100.

To ensure that when the door is closed it does not disappear too far into the wall pocket, a stop must be used to prevent the movement of the door carrier after sliding to a certain point on the track 100.

Normally access to the door pocket is only possible until the wall surface (i.e. the plasterboard panel) is fixed in place. After then, the end of the track 100 within the door pocket becomes difficult to access. To address this, referring to FIG. 13C, a groove 102 may be formed in the track above the point where the door carrier 101 slides. This groove 102 will be shaped such that a strip may be fed through it from its front end. It is arranged such that is would be difficult or impossible to remove this strip vertically through the outer open bottom of the groove 102 with it remaining intact.

FIGS. 13, 13B and 13C show a setting strip 103 which is shaped such that it may be fed through the groove without encroaching on the space of the track 100 in which the door carrier 101 travels. On the end of the setting strip 103 is a stop or stopping member 104, this stop 104 is shaped such that it fits through the bottom open gap of the groove 102 so as to encroach into the space of the track 100 along which the door carrier 101 travels. The purpose of this stop 104 is to stop the door carrier 101 from travelling further along the track 100 than desired and thus preventing the door from sliding too far into the door pocket.

To ensure the stop 104 may handle the forces of the door carrier 101 which will act upon it when the door is pushed into the door pocket, the stop 104 when viewed from the side has a vertical face which encroaches into the track space 100 and has an angled support behind the vertical face which is joined to the setting strip 102. It is thus wedge shaped, or block shaped. This reduces the likelihood of the door carrier 101 causing deformation or failure of the door stop 104 if it was to bang against it.

The purpose of the stop 104 being attached to a setting strip 103 which slides through the groove 102 is to allow installation of the stop 104 after the wall surface has been installed. This is achieved by sliding the setting strip 103 through the groove 102 from the open accessible end 105 as shown in FIG. 13. Although the setting strip and stop will be constrained vertically, to prevent horizontal movement of the setting strip 103 along the groove 102 due to the forces exerted by the door carrier 101 on the stop 104, there is provided a fixing point 106 for the open end 105 of the setting strip 103.

This fixing point 106 may take the form of a hole within the setting strip 103 through which a screw or nail may be inserted upwards through the top of the track 100 thereby constraining the setting strip 103 and attached stop 104 from moving horizontally along the direction of the movement of the door carriers 101.

A number of materials may be used for forming the setting strip 103 and stop 104 as long as they are adequately rigid and tough to ensure the setting strip does not stretch or deflect too much. It also will have to withstand constant cyclic loading caused by the door and also the likely impact forces of the door carrier 101 rolling into the stop 104. As such, metals or fibre reinforced plastic materials are most suitable material for forming the strip and stop.

Without such a stop, the door carrier 101 would travel further along the track 100 than desired. Where the door then also does not have a protruding handle, the door could roll fully into the cavity, it thus being difficult to pull out of the pocket when it wants to be closed (or the door carrier 101 could even travel so far that it comes out of the track 100 on an opposite end thereof. It is, expected, however, that the door would have a handle, whereby the handle would hit the jamb, thus preventing a full retraction of the door into the cavity even if no stop 104 was present. However, allowing the handle to hit the inner jamb of the frame would be undesirable since it could damage both the visible surface of the jamb and the door handle. The stop is thus beneficial.

The advantage of being able to set the stop after installation of the wall surface is that completion of the door need not prevent the finishing of a room, and thus jobs such as plastering or painting can be done while a door is yet to be installed. This also allows changes to the door, such as a wider door or a differently positioned handle to be enacted after installation of the original door, since the stop can be easily moved or adjusted.

An additional feature of the track 100, as shown in FIG. 13A, are indentations 107 in the top of the track 100. These indentations 107 are small grooves and they run along the length of the track 100 and are shaped such that they pair up with the raised curved protrusion caused by nodules 108 in the top support 30 as seen in FIGS. 3A, 3B and 3C. The pairing of these nodules 108 and notches 107 ensure that when the track 100 is fixed into the top support 30, it will be correctly aligned straight along the length of the top support without the need for further tools or measurements. This thus ensures the correct assembly. This again speeds up installation of the door frame.

FIGS. 14A to 14D show a base bracket 110 for locating the bottom of the sliding door when it travels in and out of the door pocket along a track at its top. The base bracket 110 has a base plate 116 which is fastened to the floor through screw holes 115. A bogie 111 is attached to the base plate 116 through its centre through a fixing member 114—a screw, bolt or pinion member 114.

Between the base plate 116 and the bogie 111 is a torsion spring 112 which attaches to both the bogie and the base plate.

On either end of the bogie 111 are wheels 113 which have their axes mounted vertically and as such the wheels 113 will lie horizontally.

The base bracket 110 is mounted such that the bogie 111 and its wheels 113 fit inside a track 117 on the base of a door.

Since the door is suspended from its top, the bottom will have a tendency to move if it is not constrained. To prevent excess movement of the door, it has been conventional to provide at the base a track with a pillar or point sitting within it. This can be used to stop excessive movement of the base of the door when it is being opened or closed. The problem with such a design is that to ensure smooth running of the door, the pillar cannot be constrained tightly within the track in the base of the door or this will result in the possibly difficult movement of the door, especially since some forces are applied horizontally perpendicular to the sliding direction of the door when using a handle. However, such a loose fit means that the door will still rattle when it is being opened or closed, or when there is a pressure difference or pressure change on either side of the door. With the torsion spring 112 of the base bracket 110 of the present invention, the torsion spring 112 can be pre-tensioned prior to the bogie 111 being inserted inside the track 117. Such a pre-tension will result in one side of the bogie 111 exerting a force on the track 117 in an opposite direction to the other side of the bogie 111. This will thus then constrain the base of the door and thus stop excess movement and prevent rattle against the bogie 111 which is always in contact with the track 117. Further, because of the arrangement of the bogie, movements of the wheel will impose forces on the bogie to allow such sliding, and the wheels 113 ensure that the door can easily slide open and closed since the wheels 113 will roll through the track 117.

The use of a base bracket 110 will also allow some movement of the base of the door as will be required to ensure a smooth opening and closing action.

The base bracket 110 is positioned within the door pocket at a point where, whether the door is opened or closed, the bogie 111 is always within the track 117 of the door. This prevents the need to initially set the bogie 111 into the track 117, or the need to torsion the spring 112 in normal operation of the door. These actions will only need to be carried out on the initial setting of a door into the sliding tracks.

An alternative arrangement according to the present invention for forming the door frame of a sliding door is now discussed. This comprises blocks formed from wood or a similar material to form the jamb and lintel. Additional finishing jambs may fit over these parts.

Referring to FIG. 15, one part of a pair of jamb blocks 120 form the outer jambs of the door frame furthest away from the door pocket. Between the jamb blocks 120 is a sealing block 130 which will receive the sliding door when it is in its closed position. A lintel block 140 joins the closing jamb 120 to the opposing, inner jamb, which may be the pair of jamb posts 40 as seen in FIG. 9 or a pair of block beams 90 as shown in FIG. 12 or another arrangement of a jamb.

Referring to FIG. 15A, the lintel block 140 is shown to be a rectangular block with grooves cut in its profile and a top strip 143 extending from the block. The top groove is a brush holder 141 which is used for mounting a sealing brush which seals or bears against the top of the door. The lower groove in the lintel block 140 is a seal channel 142 for holding a seal which also seals or bears against the top of the door. This seal channel 142 is suited for holding an intumescent seal for preventing the spread of fire through the closed doorway. Such a strip has been previously discussed in relation to an earlier embodiment. Such an arrangement is advantageous since the door is sealed on its top edge to prevent the passage of smoke, light, temperature, etc.

The top strip 143 of the lintel block 140 is used for fastening inside the channel 37 of the top support 30. The block can then be secured in position in the top support 30 through countersunk screw holes 39. A surface 144 is provided on the lintel block 140 against which wall material, such as a panel of plasterboard, may sit. This ensures that the edge of the wall material is hidden, and if a finishing lintel is required, the lintel block 140 will provide a flat surface for it to fasten against.

A pair of lintel blocks 140 will be used to form the lintel on either side of the door opening, thus fitting in both of the channels 37 of the top support 30.

FIG. 15B shows the profile of the jamb block 120. This is a mostly rectangular block which has a groove cut in its profile. Again, as with the lintel block 140, this groove 121 can be used for receiving a seal, or intumescent seal. A seal in this position will ensure that, in combination with the block beam 90 of FIG. 12, that each jamb of a closed sliding door will have a seal. This increases the fire retardation of the sliding door.

Jamb block 120, has a removed section 122 for receiving the sealing block 130 as shown in FIG. 15C. The sealing block 130 has a rectangular profile with two narrow grooves 131 which face the edge of the door when closed. These grooves 131 can house closing seals 132, as shown in FIG. 15. These closing seals 132 have an additional action to the seals discussed previously, in that they provide buffering between the door and the frame, in particular the sealing block 130 when the door is closed. The closing seals 132 are likely to be made from a soft material such as rubber, thereby protecting the door's edge when it touches upon them. The closing seals 132 also stop the bang or slam of a two solid objects hitting against one another, such as the door hitting against the seal block 130. The closing seal 130 is also shaped such that the edge of the jamb block is hidden and the seals are sloped toward the centre of the seal clock 130. This ensures that if the door is not central in its sliding groove, perhaps due to a horizontal force, that the closing seals 132 will ensure that the closed door is moved such that it sits centrally within the door frame.

Although finishing jambs or lintels which allow a finished wall to transition up to the door with no broken surface are described, a more conventional, visible doorframe and architrave may be provided as the finishing frame for the door. Such arrangements are shown in FIGS. 16 to 18.

FIG. 16 shows a top of a frame 150, according to the present invention. A pair of block beams 152 are arranged on the pocket side of the frame 150 against the block posts 80. The block beams 152 have slots 154, for example to allow an intumescent seal to provide fire retardation. The lintel 156 (only one is shown in this example) again has a seal slot 158 and a brush slot 160—typically for fire resistance purposes. Completing the frame are a pair of jamb blocks 162 arranged on the closing side of the frame. These jamb blocks 162 have slots 154 to receive a seal and between them is a sealing block 164, which has two narrow grooves 166 facing the door to receive a closing seal.

This frame differs compared to the previous example, particular as shown in FIGS. 12 and 15, since there is no finishing jamb, and instead the faces of the block beams 152 or 162 are the final jamb for the door. Similarly, the pair of lintels 156 form the finishing frame for the lintel of the door.

FIG. 17 shows a top of a frame 170, similar to the frame of FIG. 16 in that additional finishing jambs are not required, but instead there are no slots for seals. This provides a cost efficient, easy to install arrangement for a door. This can have particular application for example where fire retardation is not a requirement. A pair of block beams 172 are shown on the pocket side of the frame 170. These block beams 172 are shown in more detail in the plan view of FIG. 17A. Here, the primary difference to the block beams seen previously is the replacement of the wide slot with a brush slot 174. In combination with the block post 80, this can provide a double brush seal for the door. The pair of lintels 176, which are shown in more detail in the plan view of FIG. 17B, forego the seal of the lintel of FIG. 16, and just have a brush slot 178. The lintel 176 is shorter than the lintel of FIG. 16, reducing the distance from the lintel 176 to the top support. This is due to the lack of need for intumescent seals on each edge, and since it reduces the requirements for shaping a finishing wall surface, it provides an easier install.

Completing the frame is a seal block 180, as seen in FIG. 17C. Unlike the example of FIG. 16, since there is no requirement to seal against the face of the door, there is no requirement for door facing jamb blocks on the closing edge. The seal block 180 has side blocks 182 which project from the profile and side partially around the door when it is closed. There are narrow slots 184 present to allow the fitting of a closing seal as discussed previously. FIG. 17D shows the top of the seal block 180, which, since it is one piece, is trimmed to allow the lintels 176 to sit on it as shown in FIG. 17.

FIGS. 16 and 17 show a configuration for the door frame using the top supports and vertical posts according to the present invention, but allowing the consumer to have a different finish for the door frame where the block may be formed from wood and sit flush within the wall surface providing a visible architrave.

FIG. 18 shows a top of a frame 190 according to the present invention. Here a frame 190 similar to those seen in FIG. 16 or 17 (depending on whether fire retardation is sought) is formed with solid beams for the jambs and lintel. However, a finishing jamb 192 is provided in the form of an L piece. This can be seen in FIG. 18A. Such a piece sits around the jambs but does not cover the solid beam completely when viewed from the front or rear of the sliding door. As such, the block beam 196 or sealing block 198 is partially visible. The lintel has an L-shaped finishing lintel 194 present which can be seen in FIG. 18B. This finishing lintel 194 ihas slightly different dimensions than the finishing jamb 192 to take into account the top support and so as not to interfere with the sliding mechanism. Again, when viewed from the front or rear of the door, the finishing lintel 194 does not completely cover the lintel block 200 underneath it. If fire retardation is required, it is possible to use blocks with wide slots for intumescent seals as seen previously.

Such an arrangement allows a wall surface to installed with a gap to the finishing jamb 192 or finishing lintel 194. Since the underlying block is still present, if a view through the gap was possible, only a block would be visible and not a vertical post. The purpose of the gap is to provide a shadow gap, where a dark frame appears around the edge of the door. This is aesthetically pleasing and also, if plastering, prevents the need to plaster right up to the blocks forming the jamb and lintel, where such a joint may be liable to cracking.

The present invention has therefore been described above by way of example. It provides a frame for a sliding door which sits within a pocket, wherein the frame comprises rigid vertical posts, which have channels which can contain material for strengthening of the posts and allowing the fastening of plasterboard or other such wall panels to the vertical posts.

Modifications in detail may be made to the invention within the scope of the claims appended hereto.

1. A frame for a sliding door, the frame comprising columns formed with extruded profiles, the columns extending between upper and lower supports of the frame, the upper and lower supports being formed with extruded profiles and with multiple channels, and a rail in or along which a door can slide.

2. The frame of claim 1, wherein the upper and lower supports provide at least one channel for the columns to be secured within and at least one channel for a sliding mechanism of the sliding door.

3-4. (canceled)

5. The frame of claim 1, wherein the profile of the column's extrusion is shaped to provide lateral rigidity.

6-8. (canceled)

9. The frame of claim 1, wherein one or more of the upper and lower supports, or the columns, is formed from a non-ferrous metal such as aluminium.

10. (canceled)

11. The frame of claim 1, wherein the columns additionally comprise a beam bonded to, or attached to, or located within, a channel within the column.

12-13. (canceled)

14. The frame of claim 11, wherein the beam is made of wood or a fibrous material.

15. The frame of claim 11, wherein the beam is oversized in its depth dimension such that it sits proud of the profile of the column when located within the channel at least over a majority of its length.

16. The frame of claim 11, wherein the column has one or more groove or wedge present along its axis, extending along at least one side of its channel, for aligning with a corresponding one or more wedge or groove, as appropriate, in the beam, for holding the beam within the channel.

17. The frame of claim 1, wherein at least one of the extruded profiles has one or more groove present along its component's axis at a location where screws or nails are to be used for securing a second component in at least one of its channels.

18. The frame of claim 1, wherein there is provided within the frame at least one jamb column, formed with an extruded profile, which forms at least a part of a jamb of the frame.

19. (canceled)

20. The frame of claim 18, wherein the jamb column's profile is such that a lip extends from it to provide increased rigidity and a surface against which a wall panel, such as plasterboard, is seated.

21. The frame of claim 18, wherein the jamb column's profile is such that there is provided a groove for a sealing member to be attached thereto.

22. The frame of claim 18, wherein the inside edge of the jamb column has a flat surface such that a visible finishing surface is placed against it.

23. The frame of claim 18, wherein an inside edge of the jamb column has a lip for securing a post against, said post forming a further part of the jamb of the frame.

24-27. (canceled)

28. The frame of claim 1, wherein the upper and lower supports are formed from an extruded profile of metal.

29. The frame of claim 1, wherein the upper and lower supports have a groove present along their axis.

30. The frame of claim 29, wherein the grooves have tapered holes predrilled at pre-defined distances along the support.

31. (canceled)

32. The frame of claim 1, wherein a raised ridge, or other locating point, is provided within the channel of the upper or lower supports, the rail having a ridge or groove which locates within the channel on the raised ridge, or other locating point, of the channel of the upper or lower support.

33. (canceled)

34. The frame of claim 1, wherein a lintel is provided at the top of the frame which locates within the channel of the upper support, wherein the lintel has at least one groove facing the sliding door for a sealing member to be secured within.

35. (canceled)

36. The frame of claim 34, wherein the lintel has a flat inner surface for a finishing lintel to be secured against and the lintel provides a surface for a wall partition panel to be seated against.

37-56. (canceled)
